(19) United States
(12) Patent Application Publication
(10) Pub. No.: US 2024/0416867 A1
(43) Pub. Date: Dec. 19, 2024

(54) ACTIVATION OF MOBILE DEVICE FOR VEHICLE

(71) Applicant: Atieva, Inc., Newark, CA (US)

(72) Inventors: Randy Almand, Oakland, CA (US); John Clark Snowdall, Jr., Boulder Creek, CA (US)

(21) Appl. No.: 18/700,206

(22) PCT Filed: Oct. 12, 2022
(86) PCT No.: PCT/US2022/077988

§ 371 Date: Apr. 10, 2024

Related U.S. Application Data
(60) Provisional application No. 63/262,408, filed on Oct. 12, 2021.

(51) Int. Cl. B60R 25/24; B60R 25/01; H04W 12/06

(52) U.S. Cl. CPC B60R 25/24; B60R 25/01; H04W 12/06

(57) ABSTRACT

A computer-based method of obtaining activation of a mobile device for a vehicle comprises: providing, to a computer system and by a mobile device, credentials for an application on the mobile device, the application to generate remote commands to the computer system for controlling the vehicle: prompting, by the mobile device, a user to invoke a user interface of the vehicle: receiving, by the mobile device, a code that the user obtained using the user interface of the vehicle: providing, by the mobile device, the code to the computer system; and receiving, by the mobile device and from the computer system, an authentication token that includes activation information identifying the vehicle, the mobile device to provide the authentication token and the activation information to the computer system in connection with generating the remote commands.

### CROSS-REFERENCE TO RELATED APPLICATION

This application claims priority to, and the benefit of the filing date of, U.S. Provisional Application No. 63/262,408, filed Oct. 12, 2021, and entitled “ACTIVATION OF MOBILE DEVICE FOR VEHICLE,” the disclosure of which is incorporated by reference herein in its entirety.

### TECHNICAL FIELD

This document relates to activation of a mobile device for a vehicle.

### BACKGROUND

Some modern vehicles may provide for interaction with a mobile device. Usually, this requires an authentication by way of a username and password. However, such traditional form of authentication may not be sufficiently secure.

### SUMMARY

In a first aspect, a computer-based method of obtaining activation of a mobile device for a vehicle comprises: providing, to a computer system and by a mobile device, credentials for an application on the mobile device, the application to generate remote commands to the computer system for controlling the vehicle; prompting, by the mobile device, a user to invoke a user interface of the vehicle; receiving, by the mobile device, a code that the user obtained using the user interface of the vehicle; providing, by the mobile device, the code to the computer system; and receiving, by the mobile device and from the computer system, an authentication token that includes activation information identifying the vehicle, the mobile device to provide the authentication token and the activation information to the computer system in connection with generating the remote commands.

Implementations can include any or all of the following features. The computer-based method further comprises receiving, by the mobile device and from the computer system, the authentication token without the activation information, wherein the authentication token without the activation information is received in response to providing the credentials and before receiving the authentication token that includes the activation information. The computer-based method further comprises providing, by the mobile device and to the computer system, the authentication token without the activation information in connection with providing the code. Receiving the code comprises perceiving, by the mobile device, the code having a machine-understandable form. Receiving the code comprises receiving, by the mobile device, input entered by the user in a human-understandable form. The computer-based method further comprises: generating, by the mobile device and after receiving the authentication token that includes the activation information, at least one of the remote commands to the computer system for controlling the vehicle; and providing, by the mobile device and in connection with generating the remote command, the authentication token that includes the activation information to the computer system. The vehicle is one of multiple vehicles for which the mobile device is activated, the method further comprising presenting, by the mobile device, a switch vehicle control to the user, wherein the user can choose any of the vehicles using the switch vehicle control for generating the remote commands.

In a second aspect, a computer-based method of activating a mobile device for a vehicle comprises: receiving, by a computer system and from a mobile device, credentials for an application on the mobile device, the application to generate remote commands to the computer system for controlling a vehicle; receiving, by the computer system and from the mobile device, a code that the mobile device received via a user interface of the vehicle; verifying, by the computer system, the received code using information in the computer system; and providing, by the computer system, in response to verification of the received code, an authentication token to the mobile device, the authentication token including activation information identifying the vehicle.

Implementations can include any or all of the following features. The computer-based method further comprises providing, by the computer system and to the mobile device, the authentication token without the activation information in response to receiving the credentials. The computer-based method further comprises: receiving, by the computer system, a code request from the vehicle, the code request received before receiving the code from the mobile device; and generating the code, by the computer system and in response to receiving the code request, and providing the generated code to the vehicle. The information in the computer system comprises the generated code. The computer-based method further comprises receiving, by the computer system, the code from the vehicle, wherein the code received from the vehicle is received before receiving the code from the mobile device. The information in the computer system comprises the code received from the vehicle. Verifying the received code comprises checking that the received code matches the information in the computer system, and checking whether the received code has expired. The computer-based method further comprises providing, by the computer system and after verifying the received code, an out-of-band communication to the user, the out-of-band communication provided other than using the application or the user interface of the vehicle. The computer-based method further comprises: receiving, by the computer system and from the vehicle, a command to identify activated devices; and in response to the command, identifying, by the computer system and to the vehicle, any devices that are activated for the vehicle. The computer-based method further comprises: receiving, by the computer system and from the vehicle, a command to revoke activation for at least one of the devices identified by the computer system; and revoking, by the computer system and in response to the command to revoke activation, the activation for the device.

In a third aspect, a computer-based method of facilitating activation of a mobile device for a vehicle comprises: receiving, by a first computer system of a vehicle, an add device command from a user, the user associated with a mobile device having an application to generate remote commands to a second computer system for controlling the vehicle, the second computer system separate from the vehicle; and providing, by the first computer system, a code to the user in response to the add device command, the code to be provided to the application for use in activating the application for the vehicle.

Implementations can include any or all of the following features. The computer-based method further comprises: providing, by the first computer system, a code request to the second computer system, the code request provided before providing the code to the user; and receiving the code, by the first computer system and from the second computer system, wherein the code that the first computer system provides to the user is the code that the first computer system received from the second computer system. The computer-based method further comprises: generating the code, by the first computer system, in response to the add device command, wherein the code that the first computer system provides to the user is the code that the first computer system generated; and providing, by the first computer system, the generated code to the second computer system. The computer-based method further comprises: receiving, by the first computer system, a user input to identify any activated devices for the vehicle; obtaining, from the second computer system, an identifier for at least one device that is activated for the vehicle; and in response to the user input, presenting, by the first computer system, the identifier for the device that is activated for the vehicle. The computer-based method further comprises: receiving, by the first computer system, a command input by the user to revoke activation for the device that is activated for the vehicle; and forwarding, by the first computer system, a revocation to the second computer system regarding the device that is activated for the vehicle.

### BRIEF DESCRIPTION OF DRAWINGS

FIG. 1 shows an example of a system that activates a mobile device for a vehicle.

FIG. 2 shows an example of a process flow regarding activation of a mobile device for a vehicle.

FIGS. 3A-3D show examples of screens that a mobile device can present regarding activation for a vehicle.

FIGS. 4A-4C show examples of screens that a vehicle can present regarding activation of a mobile device for the vehicle.

FIG. 5 illustrates an example architecture of a computer system.

FIGS. 6A-6D show another example of a sign-in procedure.

Like reference symbols in the various drawings indicate like elements.

### DETAILED DESCRIPTION

This document describes examples of systems and techniques providing activation of a mobile device for a vehicle. In some implementations, device activation requires a customer to interact with a vehicle infotainment system. For example, the infotainment system can present a multi-character code to the user that is valid for a certain time. The code should be entered into the mobile device and submitted to a backend before it expires. Such a procedure can activate the mobile application to send remote commands for controlling the vehicle.

Examples described herein refer to a vehicle. As used herein, a vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. A vehicle can be powered by one or more types of power sources. In some implementations, a vehicle is powered solely by electricity, or can use one or more other energy sources in addition to electricity, to name just a few examples.

Examples described herein refer to a mobile device generating a remote command for a vehicle. As used herein, a remote command is not transmitted directly from the mobile device to the vehicle. Rather, a remote command as used herein involves at least one intermediate device or system to receive the remote command generated by the mobile device, which intermediate device/system verifies the remote command in one or more ways. Only the remote command(s) verified as valid by the intermediate device/system will be forwarded to the vehicle for execution. A remote command that the intermediate device/system does not verify will not be forwarded to the vehicle. The intermediate device/system that verifies a remote command for a vehicle can include a backend system or any other server, for example.

Examples described herein refer to a code in human-understandable form. As used herein, human-understandable form refers to information that is normally understood by a human. Examples of information in human-understandable form include, but are not limited to, a string of characters (e.g., numbers and/or letters), spoken language, or symbols.

Examples described herein refer to a code in machine-understandable form. As used herein, machine-understandable form refers to information that is normally understood by a machine. Information that is human-understandable can also be machine-understandable. Examples of information in machine-understandable form include, but are not limited to, a QR code, a bar code, or a hash.

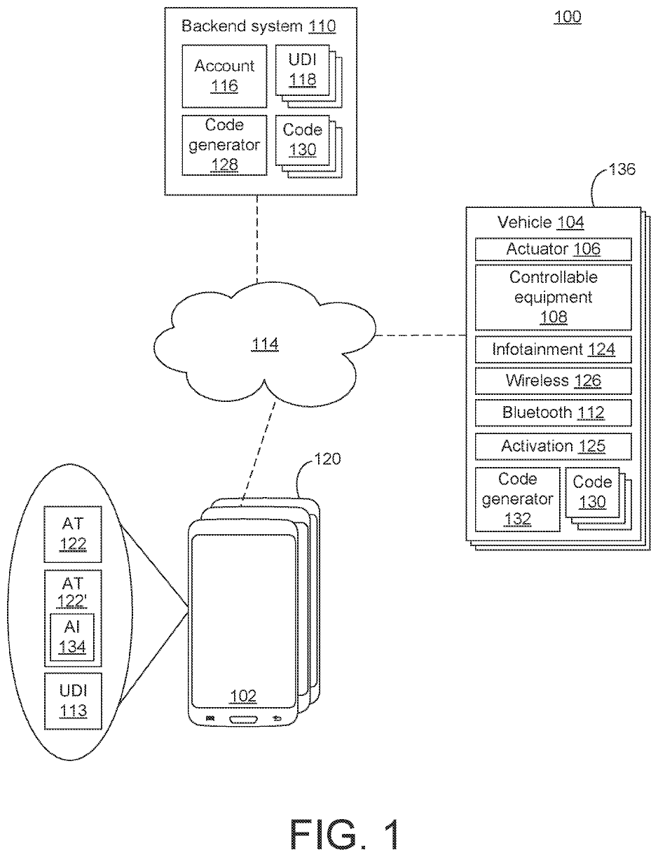

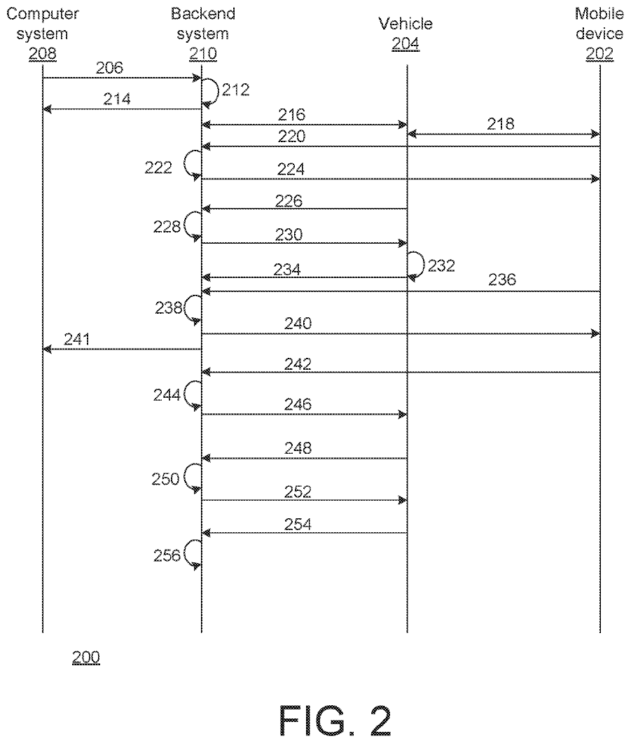

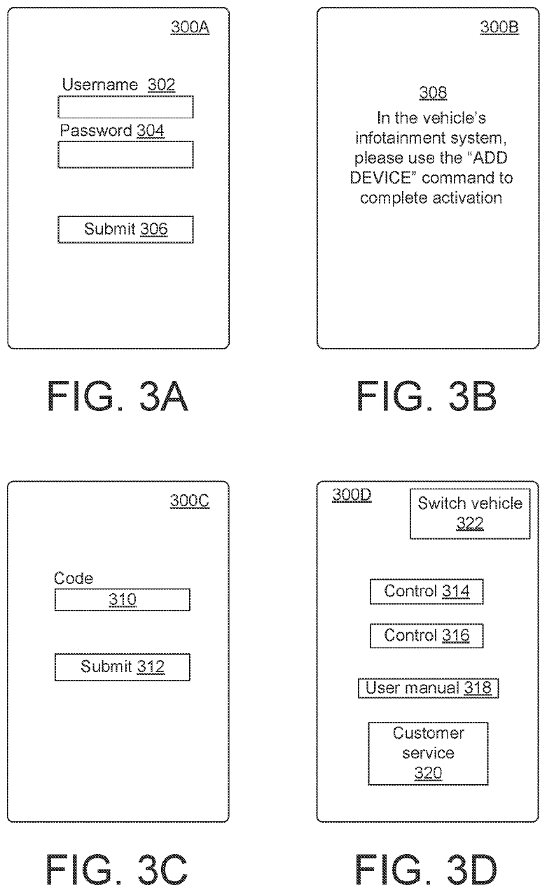

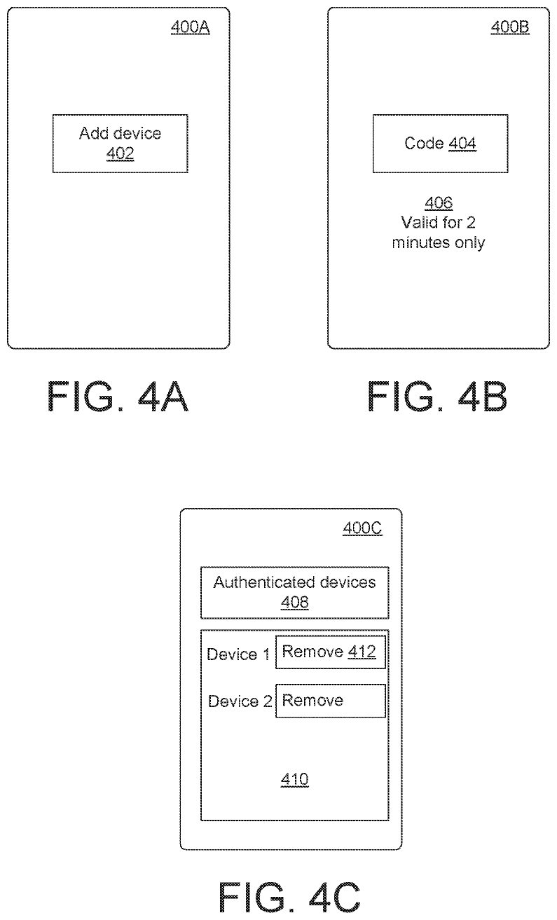

FIG. 1 shows an example of a system 100 that activates a mobile device 102 for a vehicle 104. FIG. 2 shows an example of a process flow 200 regarding activation of a mobile device 202 for a vehicle 204. FIGS. 3A-3D show examples of screens 300A-300D that a mobile device can present regarding activation for a vehicle. FIGS. 4A-4C show examples of screens 400A-400C that a vehicle can present regarding activation of a mobile device for the vehicle. The examples of the present disclosure are presented below with reference to one or more of the drawings. Generally, reference numbers used herein are associated with their respective drawing by way of their first digit. For example, reference numbers 1 are shown in FIG. 1, and so on. An example described herein with reference to any of the drawings can be combined with one or more other examples described elsewhere herein.

In the following, examples will be presented in a sequence as they may occur in an actual scenario where a person creates an account (e.g., a production account) for the vehicle 104; obtains a software application for the mobile device 102 relating to the vehicle 104; takes delivery of the vehicle 104; authenticates the mobile device 102; activates the mobile device 102 for generating one or more remote commands for the vehicle 104; and uses the mobile device 102 to control the vehicle 104 by way of the remote command(s).

Arrow 206 schematically illustrates that a user employs a computer system 208 to request an account with a backend system 210. In some implementations, the backend system 210 can be any computer system (including, but not limited to, one or more servers and/or a cloud solution) operated on behalf of a manufacturer or other vendor of the vehicle. Arrow 212 schematically illustrates that the backend system 210 creates the account for the user, including, but not limited to, by storing user information such as credentials (e.g., username and password). Arrow 214 schematically illustrates that the backend system 210 confirms the account to the computer system 208. The computer system 208 can be separate from the mobile device 202, or the computer system 208 can be the mobile device 202, to name just two examples.

Using the created account, the user can place an order for a vehicle with the manufacturer/vendor. If the order involves manufacturing of a specific vehicle, the account can be referred to as a production account. In other scenarios, the user may be obtaining an already manufactured vehicle (e.g., a new or used vehicle). Once the user's purchase order is connected with a unique vehicle identification number (VIN) for the vehicle, the VIN can be associated with the user's account.

Arrow 216 schematically illustrates that communication can occur between the vehicle 204 and the backend system 210 in either or both directions. In some implementations, when a vehicle is being manufactured the vehicle's computer(s) can be provided with the appropriate software or other configurations. Testing can be performed. For example, such installations can prepare the vehicle for later participating in an activation process for the mobile device 202, and/or for later being controlled by the mobile device 202 by way of remote command(s). Other approaches can be pursued.

Once the vehicle 104 is ready (e.g., at an end of manufacturing process), the user can take delivery of the vehicle 104. Once the vehicle 104 is delivered, the user can employ a key, a fob, or other unlocking tool to gain access to the vehicle 104; this can allow the user to drive (or ride in) the vehicle 104 and operate its various functions by way of actuating different controls. However, at this point in the sequence, the mobile device 102 has not been activated for controlling the vehicle 104 by remote command; rather, examples described below illustrate how the mobile device 102 can first become authenticated by a backend system 110 that is associated with the vehicle 104. The backend system 110 is separate from (e.g., not included within) the vehicle 104. Thereafter the mobile device 102 can be activated to permit control of the vehicle 104 by remote command.

Independent of remote commands, other forms of interaction with the vehicle 104 may already or subsequently be available to the user before activation. Such interaction can occur by way of short-range wireless communication. In some implementations, the vehicle 104 includes a BLUETOOTH module 112 (e.g., including one or more chipsets configured for signaling according to that standard of wireless communication). For example, arrow 218 schematically illustrates that BLUETOOTH pairing and/or BLUETOOTH communication between the mobile device 202 and the vehicle 204 can occur. BLUETOOTH communications can occur whether or not the mobile device 102 has been activated for the vehicle 104.

The vehicle 104 can have an actuator 106 and/or controllable equipment 108 that an owner or other operator of the vehicle 104 may wish to operate from the mobile device 102. The actuator 106 or controllable equipment 108 can relate to any of multiple components or other features of the vehicle 104. Examples of aspects controllable by remote command can include, but are not limited to, moving a closure (e.g., trunk, liftgate, hood, window, sunroof, and/or door); operating climate-control equipment (e.g., to heat or cool a passenger cabin or an individual seat); operating vehicle conditioning equipment (e.g., to precondition a battery or a part of a drivetrain); operating a vehicle lock; or sounding a vehicle horn.

To be able to use the mobile device 102 to generate remote commands for the vehicle 104, the user can initiate a process of activating the mobile device 102 with regard to the vehicle 104. This can begin with authenticating the mobile device 102 with regard to the backend system 110. Screen 300A shows a graphical user interface that can be generated by an application executed on the mobile device. Such application on the mobile device 102 is associated with the vehicle 104 and can be configured so that, once the mobile device 102 is activated, the remote command(s) can be generated using that application on the mobile device 102. In some implementations, the application prompts the user to enter credentials for the user's account with the backend system 110. In some implementations, the credentials include a username 302 and a password 304. For example, the credentials may have become associated with the user upon creation of a production account. The application can provide a submit control 306 to forward the credentials from the mobile device 102 for receipt by the backend system 110. Arrow 220 schematically illustrates that the mobile device 202 provides the credentials for the application to the backend system 210.

In connection with providing the credentials to the backend system 110, the mobile device 102 also provides a unique device identifier (UDI) 113 to the backend system 110. For example, the UDI 113 can be a persistent UDI (e.g., a media access control (MAC) address, or any other physical address or hardware address). As another example, the UDI 113 can be a rotating UDI, which can be a software-assigned proxy for a persistent UDI that is likewise not correlated with any other device and that may not be used by any other application on the mobile device 102.

In some implementations, such communication between the mobile device 102 and the backend system 110 can be transmitted via one or more network 114 (including, but not limited to, the internet). The application on the mobile device 102 can use any of multiple communication protocols to provide information to the backend system 110. For example, the communication can be conveyed via HTTP-based protocol (e.g., in form of a representation state transfer (REST)); Google remote procedure calls (gRPC); Apache Thrift; and/or MQTT protocol. Other suitable protocols can be used.

Arrow 222 schematically illustrates that the backend system 210 checks the credentials of the mobile device 202 against information in that user's account. In some implementations, the backend system 110 has an account 116 associated with the user. If the received credentials are determined to be valid for the account, the backend system 110 can also check the UDI 113 against a set of one or more UDIs 118 that have previously been used for that customer and that are therefore recorded by the backend system 110. For example, if the user has already authenticated another mobile device 120 for the vehicle 104, the UDI for the other mobile device 120 is included among the UDIs 118. If no other mobile device has previously been activated for the vehicle 104, the set of the UDIs 118 may be empty.

If the mobile device 102 has not previously been activated for the vehicle 104, arrow 224 schematically illustrates that the backend system 210 can prompt the user to initiate an activation procedure for the mobile device 202. In some implementations, screen 300B can include content 308 to that effect. For example, the content 308 can instruct the user to use the vehicle's infotainment system, which may make available an “add device” command.

In connection with providing the prompt to the user, the backend system 110 can provide an authentication token (AT) 122 which contains security credentials for the mobile device 102 with regard to the backend system 110. In future communications from the application on the mobile device 102 to the backend system 110, the AT 122 can be included, to allow the backend system 110 to know who is making the call, and to confirm that the call is legitimate. For example, the AT 122 that the backend system 110 provides to the mobile device 102 can be encrypted. The AT 122 represents that the mobile device 102 has been authenticated with regards to the backend system 110. However, as noted, the mobile device 102 has not yet been activated to generate remote commands for the vehicle 104. The AT 122 reflects the authenticated-not-yet-activated status of the mobile device 102. For example, the AT 122 does not include activation information identifying the vehicle 104.

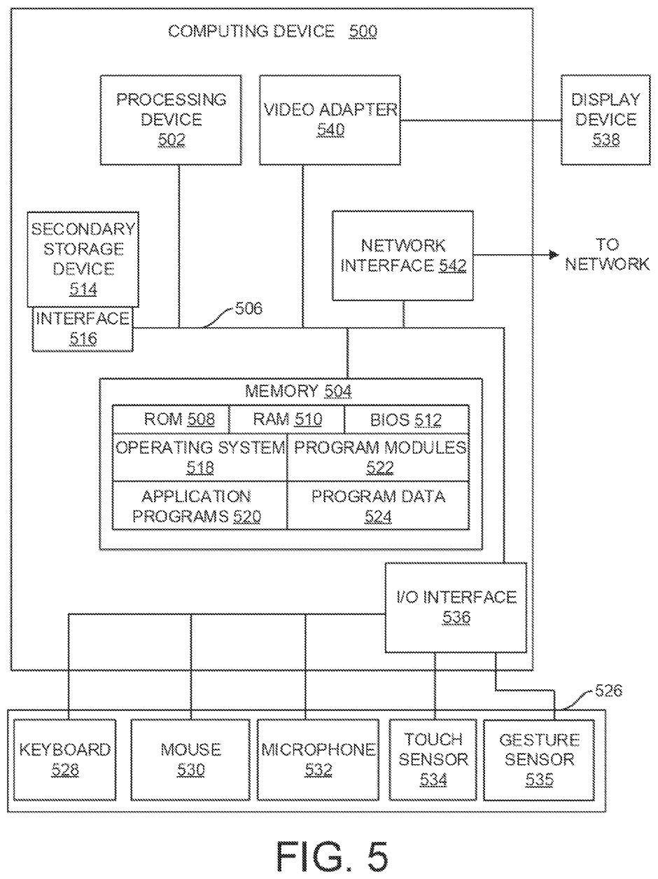

Upon being informed that the mobile device 102 is not yet activated for the vehicle 104, the user can access an infotainment system 124 of the vehicle 104. The infotainment system 124 can be implemented using some or all components described with references to FIG. 5. For example, the infotainment system 124 can provide a human-machine interface for interacting with the computer(s) of the vehicle 104. This can be done using a graphical user interface, such as with touchscreen input technology, and/or by a voice recognition for spoken commands, to name just two examples. The vehicle 104 can include an activation component 125 for performing one or more operations to facilitate activation. Screen 400A shows that the user interface of the vehicle's infotainment system can provide a control 402 for generating an add device command to the backend system.

Activating the mobile device 202 will be effectuated in part by presentation of a unique code on the infotainment system of the vehicle 204, and by entry of that code into the mobile device 202. For example, temporal proximity between such code presentation and code entry can seek to ensure that the person involved in obtaining activation for the mobile device 202 has valid access to the vehicle 204. Examples described in the following will illustrate, first, that such a unique code can be generated by the backend system 210, and, second, that such a unique code can be generated by the vehicle 204.

The following example involves generation of the unique code by the backend system. In response to an add device command, the activation component 125 can trigger the vehicle 104 to request a unique code from the backend system 110 that can be presented to the user. Arrow 226 schematically illustrates that the vehicle 204, triggered by the add device command, can provide a code request to the backend system 210. In some implementations, such communication between the vehicle 104 and the backend system 110 can be transmitted via the network 114. The infotainment system 124 can use a wireless network interface 126 for communication to and from the network 114 and/or another network. The wireless network interface 126 can engage in communications according to any of multiple protocols to provide information to the backend system 110. For example, the communication can be conveyed via HTTP-based protocol (e.g., REST); gRPC; Apache Thrift; and/or MQTT protocol. Other suitable protocols can be used.

Arrow 228 schematically illustrates that the backend system 210 can generate a unique code for the code request. The backend system 110 can use a code generator 128 to generate a code 130. The code generator 128 can generate the code 130 based on a cryptographic seed. The code 130 can be in human-understandable and/or machine-understandable form. The code 130 can include, but is not limited to, a character string, a hash, a QR code, or another form of information. Arrow 230 schematically illustrates that the backend system 210, in response to the code request, provides the code 130 that the backend system 210 generated.

The following example involves generation of the unique code by the vehicle. In response to an add device command, the activation component 125 can trigger the vehicle 104 to generate a unique code that can be presented to the user. Arrow 232 schematically illustrates that the vehicle 204 generates the unique code. In the vehicle 104, a code generator 132 can generate the code 130. The code generator 132 can generate the code 130 based on a cryptographic seed. The activation component 125 can trigger the vehicle 104 to provide the code 130 generated by the code generator 132 to the backend system 110. In some implementations, such communication between the vehicle 104 and the backend system 110 can be transmitted via the network 114. Arrow 234 schematically illustrates that the vehicle 204 provides the code, generated by the vehicle 204, to the backend system 210.

That is, whether the code 130 is generated by the vehicle 104 or by the backend system 110, the backend system 110 will be in possession of that unique code, and can later use it to authenticate the mobile device 102, as will be exemplified below. Before that example is described, it will be exemplified how the mobile device comes into possession of the code 130.

Screen 400B shows that the user interface of the vehicle's infotainment system can include a code presentation feature 404 for providing the unique code. In some implementations, the code presentation feature 404 includes at least a portion of a display screen in the vehicle. For example, the code presentation feature 404 can show a character string, a QR code, or any other form of information embodying the unique code. The user interface can include content 406 indicating whether, and if so when, the code provided by the code presentation feature 404 will expire. In some implementations, the screen 400B is available after the user signs into the vehicle's computer system. For example, the user enters a username (e.g., email address) and a password into the vehicle's infotainment system.

The code provided by the code presentation feature 404 should be provided to the mobile device to facilitate activation. Any of multiple ways of transferring content from the user interface of the infotainment system 124 to the mobile device 102 can be used. In some implementations, the unique code is human-understandable. The user can read the code at the infotainment system 124 and thereafter enter input into the mobile device 102 by way of a keypad and/or a touchscreen input device. Screen 300C shows that the application on the mobile device can include an input field 310 for the user to enter the code. In some implementations, the unique code is machine-understandable and mobile device 102 can perceive the code using one or more sensors or other input devices. For example, such a code can include a QR code or another form of information that can be obtained using a camera or other image sensor.

Screen 300C also includes a submit control 312 for triggering the mobile device to provide the code to the backend system. Arrow 236 schematically illustrates that the mobile device 202 provides the code, obtained from the user interface of the vehicle 204, to the backend system 210. For example, the mobile device 102 can include the AT 122 in connection with providing the code 130 received via the user interface of the infotainment system 124.

Arrow 238 schematically illustrates processing by the backend system 210 regarding the communication from the mobile device 202. The AT 122 received in connection with the communication from the mobile device 102 can allow the backend system 110 to know that the mobile device 102 is making the call, and to confirm that such a call is legitimate. The backend system 110 verifies the code 130 received from the mobile device 102 using information in the backend system 110. The backend system can already be in possession of the code 130, either because the code 130 was originally generated by the backend system 110, or because the backend system 110 received the code 130 as generated by the vehicle 104. For example, the backend system 110 can check that the code 130 received from the mobile device 102 matches the code 130 that the backend system 110 already has in its possession. The backend system 110 can also check whether the code 130 received from the mobile device 102 has expired. For example, an expiration time may have been defined by the backend system 110 or by the vehicle 104.

Arrow 240 schematically illustrates that the backend system 210 can respond to the mobile device 202. If the backend system 110 cannot verify the code 130 received from the mobile device 102, then the backend system 110 does not activate the mobile device 102 for the vehicle 104. In some implementations, the backend system can then provide an error message or equivalent communication to the mobile device 102. For example, such communication can reflect the authenticated-not-yet-activated status of the mobile device 102.

If the backend system 110 verifies the code 130 received from the mobile device 102, then the backend system 110 activates the mobile device 102 for the vehicle 104. Activation can involve the backend system 110 performing one or more tasks. In some implementations, the backend system 110 adds the UDI 113 to the UDIs 118 (if any) that are already activated. In some implementations, the backend system 110 can provide an AT 122′ to the mobile device 102. The AT 122′ includes activation information (AI) 134 in addition to any information carrying over from the AT 122. The AI 134 identifies the vehicle 104 to the backend system 110.

The backend system 210 can confirm the activation in one or more ways. Arrow 241 schematically shows that the backend system 210 provides an out-of-band communication to the user. The out-of-band communication is provided other than by the user interface of the vehicle 204 or the application of the mobile device 202. In some implementations, the out-of-band communication can be an email to the user. For example, the backend system 110 can use an email address that is associated with the user's account 116.

Arrow 242 schematically illustrates that the mobile device 202 can generate a remote command for controlling the vehicle 204 to the backend system 210. Screen 300D shows that the application executed on the mobile device can include one or more controls 314 or 316 associated with respective remote commands. The user can generate any of the remote commands by actuating the control 314 or 316. The mobile device 102 will then send the remote command(s) to the backend system 110.

The mobile device 102 can provide the AT 122′ having the AI 134 in connection with such a remote command. Arrow 244 schematically illustrates that the backend system 210 verifies the remote command received from the mobile device 202. The AT 122′ allows the backend system 110 to know who is making the call, to confirm that the call is legitimate, and to confirm that the mobile device 102 is activated to provide remote commands to the vehicle 104. Arrow 246 schematically illustrates that the backend system 210 provides the remote command received from the mobile device 202 to the vehicle 204 for execution.

The vehicle 104 accepts remote commands received from the backend system 110 and may not need to perform verification with regard to the mobile device 102 in this regard. Rather, the vehicle 104 can perform one or more operations as specified by the remote command(s). For example, the vehicle 104 can invoke the actuator 106 and/or the controllable equipment 108 as requested. That is, the mobile device 102, which has been activated for the vehicle 104, can now control the vehicle 104 by way of remote command.

As mentioned, the backend system does not permit remote commands for the vehicle from a mobile device that is not activated. In some implementations, the application on the mobile device 102 detects whether the mobile device 102 is activated (e.g., by way of whether the AT 122′ with the AI 134 is present). The application can prevent sending of remote commands from the mobile device 102 to the backend system 110 until the mobile device 102 is activated. The control 314 and/or 316 can then be grayed out or omitted from the screen 300D.

Before activation, one or more other operations with regard to the vehicle 104 can be available to the mobile device 102. In some implementations, this relates to operations that are relatively minor and/or that may already be available to the user by other means. Screen 300D shows that the application executed on the mobile device can include one or more controls 318 or 320 that are active when the mobile device has been authenticated, whether or not activation has occurred. For example, the control 318 allows the user to access a vehicle user manual, and the control 320 can be used for contacting customer service regarding the vehicle.

The mobile device 102 can be activated and/or authenticated with regard to both the vehicle 104 and at least another vehicle 136. For example, the owner of the mobile device 102 owns or controls at least the vehicles 104 and 136. As another example, the mobile devices 102 and 120 can both be activated and/or authenticated with regard to the vehicle 104. For example, the mobile devices 102 and 120 are owned or controlled by respective persons who share in the use of the vehicle 104. Such sharing arrangements can occur between family members or friends, or due to multiple people having contractual relationships with a third party that owns the vehicle 104, to name just a few examples. Each of the vehicles 104 and 136 has its own VIN, and the mobile devices 102 and 120 each has a respective UDI. The system 100 can facilitate a many-to-many linking map to record and manage the activations and/or authentications that apply to the respective mobile devices with regard to the vehicles. Screen 300D shows that the application executed on any mobile device can include a switch vehicle control 322. For example, if the controls 314 and 316 are currently configured for generating remote commands to a first vehicle, then the user can choose a second vehicle by actuating the switch vehicle control 322 to instead use the controls 314 and 316 (and/or other controls) for generating remote commands to the second vehicle. The remote commands that are available to be generated by the mobile device 102 and/or 120 can differ depending on which of the vehicles 104 or 136 is to be controlled.

The activation of the mobile device 102 can remain in effect for only a specified time, or indefinitely until revoked. The owner of the vehicle can check which mobile devices are currently activated for that vehicle. Screen 400C shows that the user interface of the vehicle's infotainment system can provide a control 408 to generate a command to identify activated devices. Actuating the control 408 can cause the vehicle's infotainment system to obtain the identifier(s) from the backend system. Arrow 248 schematically shows that the vehicle 204 requests from the backend system 210 the identifier(s) for any mobile device that is activated for the vehicle 204. Arrow 250 schematically shows that the backend system 210 finds the identifier(s) for any mobile device that is activated for the vehicle 204, and provides the identifier(s) as indicated by arrow 252.

Screen 400C also shows that the user interface of the vehicle's infotainment system can present content 410 to the user. The content 410 can identify to the user any mobile devices that are activated for the vehicle. Each mobile device identified in the content 410 can have a control 412 to revoke activation for that mobile device. Arrow 254 schematically shows that the vehicle 204 forwards a revocation to the backend system 210 regarding at least one mobile device. Arrow 256 schematically shows that the backend system 210 revokes the activation(s) for the mobile device(s) as requested by the vehicle 204. Accordingly, the mobile device(s) are no longer activated for the vehicle 204 and cannot control the vehicle 204 by remote command. For example, such mobile device(s) 102 or 120 may still remain authenticated with regard to the backend system 110.

FIG. 5 illustrates an example architecture of a computing device 500 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 5 can be used to execute the operating system, application programs, and/or software modules (including the software engines) described herein.

The computing device 500 includes, in some embodiments, at least one processing device 502 (e.g., a processor), such as a central processing unit (CPU). A variety of processing devices are available from a variety of manufacturers, for example, Intel or Advanced Micro Devices. In this example, the computing device 500 also includes a system memory 504, and a system bus 506 that couples various system components including the system memory 504 to the processing device 502. The system bus 506 is one of any number of types of bus structures that can be used, including, but not limited to, a memory bus, or memory controller; a peripheral bus; and a local bus using any of a variety of bus architectures.

Examples of computing devices that can be implemented using the computing device 500 include a desktop computer, a laptop computer, a tablet computer, a mobile computing device (such as a smart phone, a touchpad mobile digital device, or other mobile devices), or other devices configured to process digital instructions.

The system memory 504 includes read only memory 508 and random access memory 510. A basic input/output system 512 containing the basic routines that act to transfer information within computing device 500, such as during start up, can be stored in the read only memory 508.

The computing device 500 also includes a secondary storage device 514 in some embodiments, such as a hard disk drive, for storing digital data. The secondary storage device 514 is connected to the system bus 506 by a secondary storage interface 516. The secondary storage device 514 and its associated computer readable media provide nonvolatile and non-transitory storage of computer readable instructions (including application programs and program modules), data structures, and other data for the computing device 500.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 514 and/or system memory 504, including an operating system 518, one or more application programs 520, other program modules 522 (such as the software engines described herein), and program data 524. The computing device 500 can utilize any suitable operating system.

In some embodiments, a user provides inputs to the computing device 500 through one or more input devices 526. Examples of input devices 526 include a keyboard 528, mouse 530, microphone 532 (e.g., for voice and/or other audio input), touch sensor 534 (such as a touchpad or touch sensitive display), and gesture sensor 535 (e.g., for gestural input). In some implementations, the input device(s) 526 provide detection based on presence, proximity, and/or motion. Other embodiments include other input devices 526. The input devices can be connected to the processing device 502 through an input/output interface 536 that is coupled to the system bus 506. These input devices 526 can be connected by any number of input/output interfaces, such as a parallel port, serial port, game port, or a universal serial bus. Wireless communication between input devices 526 and the input/output interface 536 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 538, such as a monitor, liquid crystal display device, light-emitting diode display device, projector, or touch sensitive display device, is also connected to the system bus 506 via an interface, such as a video adapter 540. In addition to the display device 538, the computing device 500 can include various other peripheral devices (not shown), such as speakers or a printer.

The computing device 500 can be connected to one or more networks through a network interface 542. The network interface 542 can provide for wired and/or wireless communication. In some implementations, the network interface 542 can include one or more antennas for transmitting and/or receiving wireless signals. When used in a local area networking environment or a wide area networking environment (such as the Internet), the network interface 542 can include an Ethernet interface. Other possible embodiments use other communication devices. For example, some embodiments of the computing device 500 include a modem for communicating across the network.

The computing device 500 can include at least some form of computer readable media. Computer readable media includes any available media that can be accessed by the computing device 500. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 500.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 5 is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device 500 can be characterized as an ADAS computer. For example, the computing device 500 can include one or more components sometimes used for processing tasks that occur in the field of artificial intelligence (AI). The computing device 500 then includes sufficient proceeding power and necessary support architecture for the demands of ADAS or AI in general. For example, the processing device 502 can include a multicore architecture. As another example, the computing device 500 can include one or more co-processors in addition to, or as part of, the processing device 502. In some implementations, at least one hardware accelerator can be coupled to the system bus 506. For example, a graphics processing unit can be used. In some implementations, the computing device 500 can implement a neural network-specific hardware to handle one or more ADAS tasks.

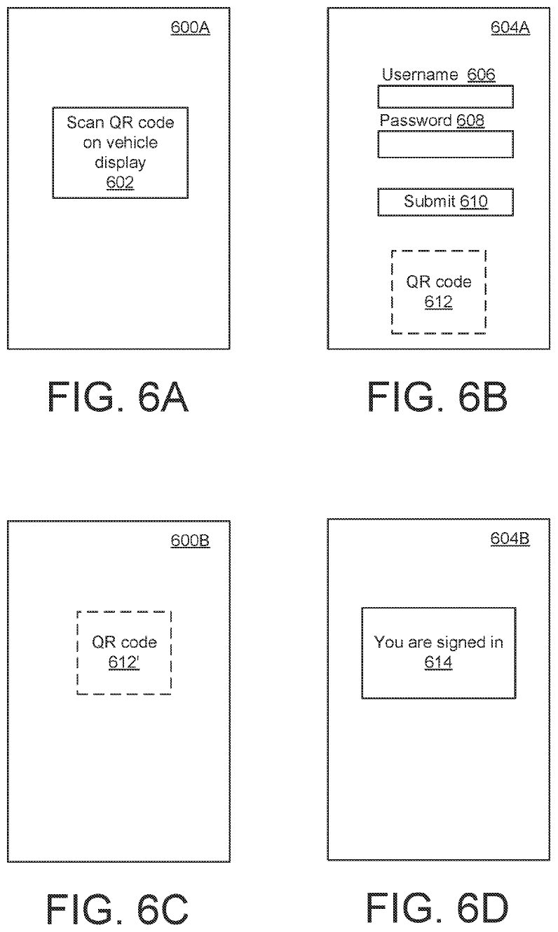

FIGS. 6A-6D show another example of a sign-in procedure. The procedure can be used with one or more other examples described elsewhere herein. As a reference, other examples described in this disclosure may have operated substantially along the following lines: 1. The customer signs into the mobile application with a username (e.g., email address) and a password. The mobile application may instruct the customer that a passcode consisting of a number of characters is to be obtained from the vehicle. 2. The customer enters the vehicle (e.g., using a keyfob or a near-field communication (NFC) device to unlock a door.) 3. The customer signs into the vehicle's computer system (e.g., by entering a username and password on the vehicle display). 4. The customer obtains the passcode from the vehicle's infotainment system. 5. The customer enters the passcode into the mobile application. 6. The customer can then use the mobile application to remotely control the vehicle.

In the example of FIGS. 6A-6D, by contrast, the procedure can be performed substantially as follows. 1. The customer signs into the mobile application with a username and password. The mobile application can present a screen 600A in FIG. 6A. For example, the screen 600A can include a message 602 instructing the customer to scan a visual code (e.g., a QR code) on the vehicle's display. 2. The customer unlocks the vehicle (e.g., using keyfob or NFC device) and enters the vehicle. 3. The vehicle's infotainment system can present a screen 604A in FIG. 6B. In some implementations, the screen 604A is the login screen for the vehicle, but the customer does not manually enter any login credentials at the screen 604A. For example, the user does not directly utilize any of a username field 606, a password field 608, or a login submit control 610. Rather, the customer scans, using the mobile device, a visual code 612 (e.g., a QR code) that is presented on the screen 604A. FIG. 6C illustrates that the mobile application shows a screen 600B where a representation 612′ of the visual code is visible. As such, the visual code 612 can be presented without the customer having logged into the vehicle computer system. Regarding the customer's bypassing of the usual login procedure in this example, the vehicle may provide a welcome sequence for all customers after receiving their new vehicle, which may involve agreeing to terms and conditions. At the end of such a sequence, the vehicle can prompt the customer to sign in using their credentials, or continue as a guest. 4. The vehicle's display can be automatically signed in using the credentials with which the customer signed into the mobile application in the most recent item 1 above. FIG. 6D shows that the vehicle computer system presents a screen 604B with content 614 indicating that the customer is logged in. The mobile application can automatically dismiss the screen 600B and be available for the customer to remotely control the vehicle. While the user here did not directly enter the credentials in the most recent item 3 above, other approaches can be used. In some implementations, this item 3 can instead be performed after the customer manually signs into the vehicle (e.g., using the username field 606, password field 608, and login submit control 610). For example, this can facilitate the customer adding another device, or be a user convenience.

The terms “substantially” and “about” used throughout this Specification are used to describe and account for small fluctuations, such as due to variations in processing. For example, they can refer to less than or equal to +5%, such as less than or equal to +2%, such as less than or equal to +1%, such as less than or equal to +0.5%, such as less than or equal to +0.2%, such as less than or equal to +0.1%, such as less than or equal to +0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A computer-based method of obtaining activation of a mobile device for a vehicle, the method comprising:
providing, to a computer system and by the mobile device, credentials for an application on the mobile device, the application to generate remote commands to the computer system for controlling the vehicle;
prompting, by the mobile device, a user to invoke a user interface of the vehicle;
receiving, by the mobile device, a code that the user obtained using the user interface of the vehicle;
providing, by the mobile device, the code to the computer system; and
receiving, by the mobile device and from the computer system, an authentication token that includes activation information identifying the vehicle, the mobile device to provide the authentication token and the activation information to the computer system in connection with generating the remote commands.

2. The computer-based method of claim 1, further comprising receiving, by the mobile device and from the computer system, the authentication token without the activation information, wherein the authentication token without the activation information is received in response to providing the credentials and before receiving the authentication token that includes the activation information.

3. The computer-based method of claim 2, further comprising providing, by the mobile device and to the computer system, the authentication token without the activation information in connection with providing the code.

4. The computer-based method of claim 1, wherein receiving the code comprises perceiving, by the mobile device, the code having a machine-understandable form.

5. The computer-based method of claim 1, wherein receiving the code comprises receiving, by the mobile device, input entered by the user in a human-understandable form.

6. The computer-based method of claim 1, further comprising:
generating, by the mobile device and after receiving the authentication token that includes the activation information, at least one of the remote commands to the computer system for controlling the vehicle; and
providing, by the mobile device and in connection with generating the remote command, the authentication token that includes the activation information to the computer system.

7. The computer-based method of claim 1, wherein the vehicle is one of multiple vehicles for which the mobile device is activated, the method further comprising presenting, by the mobile device, a switch vehicle control to the user, wherein the user can choose any of the vehicles using the switch vehicle control for generating the remote commands.

8. A computer-based method of activating a mobile device for a vehicle, the method comprising:
receiving, by a computer system and from the mobile device, credentials for an application on the mobile device, the application to generate remote commands to the computer system for controlling the vehicle;
receiving, by the computer system and from the mobile device, a code that the mobile device received via a user interface of the vehicle;
verifying, by the computer system, the received code using information in the computer system; and
providing, by the computer system, in response to verification of the received code, an authentication token to the mobile device, the authentication token including activation information identifying the vehicle.

9. The computer-based method of claim 8, further comprising providing, by the computer system and to the mobile device, the authentication token without the activation information in response to receiving the credentials.

10. The computer-based method of claim 8, further comprising:
receiving, by the computer system, a code request from the vehicle, the code request received before receiving the code from the mobile device; and
generating the code, by the computer system and in response to receiving the code request, and providing the generated code to the vehicle.

11. The computer-based method of claim 10, wherein the information in the computer system comprises the generated code.

12. The computer-based method of claim 8, further comprising receiving, by the computer system, the code from the vehicle, wherein the code received from the vehicle is received before receiving the code from the mobile device.

13. The computer-based method of claim 12, wherein the information in the computer system comprises the code received from the vehicle.

14. The computer-based method of claim 8, wherein verifying the received code comprises checking that the received code matches the information in the computer system, and checking whether the received code has expired.

15. The computer-based method of claim 8, further comprising providing, by the computer system and after verifying the received code, an out-of-band communication to the user, the out-of-band communication provided other than using the application or the user interface of the vehicle.

16. The computer-based method of claim 8, further comprising:
receiving, by the computer system and from the vehicle, a command to identify activated devices; and
in response to the command, identifying, by the computer system and to the vehicle, any devices that are activated for the vehicle.

17. The computer-based method of claim 16, further comprising:
receiving, by the computer system and from the vehicle, a command to revoke activation for at least one of the devices identified by the computer system; and
revoking, by the computer system and in response to the command to revoke activation, the activation for the device.

18. A computer-based method of facilitating activation of a mobile device for a vehicle, the method comprising:
receiving, by a first computer system of the vehicle, an add device command from a user, the user associated with the mobile device, the mobile device having an application to generate remote commands to a second computer system for controlling the vehicle, the second computer system separate from the vehicle; and
providing, by the first computer system, a code to the user in response to the add device command, the code to be provided to the application for use in activating the application for the vehicle.

19. The computer-based method of claim 18, further comprising:
providing, by the first computer system, a code request to the second computer system, the code request provided before providing the code to the user; and
receiving the code, by the first computer system and from the second computer system, wherein the code that the first computer system provides to the user is the code that the first computer system received from the second computer system.

20. The computer-based method of claim 18, further comprising:
generating the code, by the first computer system, in response to the add device command, wherein the code that the first computer system provides to the user is the code that the first computer system generated; and
providing, by the first computer system, the generated code to the second computer system.

21. The computer-based method of claim 18, further comprising:
receiving, by the first computer system, a user input to identify any activated devices for the vehicle;
obtaining, from the second computer system, an identifier for at least one device that is activated for the vehicle; and
in response to the user input, presenting, by the first computer system, the identifier for the device that is activated for the vehicle.

22. The computer-based method of claim 21, further comprising:
receiving, by the first computer system, a command input by the user to revoke activation for the device that is activated for the vehicle; and
forwarding, by the first computer system, a revocation to the second computer system regarding the device that is activated for the vehicle.

23. The computer-based method of claim 1, wherein receiving the code comprises scanning, using the mobile device, a visual code presented at the user interface of the vehicle.

24. The computer-based method of claim 23, wherein the visual code is presented at the user interface without the user having logged into the computer system of the vehicle.

25. The computer-based method of claim 18, wherein providing the code comprises presenting a visual code at a user interface of the vehicle.

26. The computer-based method of claim 25, wherein the visual code is presented at the user interface without the user having logged into the first computer system of the vehicle.
